(19) United States
(12) Patent Application Publication
(10) Pub. No.: US 2008/0088978 A1
(43) Pub. Date: Apr. 17, 2008

(54) HEAT TRANSFER FOR A HARD-DRIVE WIRE-BOND PRE-AMP

(75) Inventors: Voon Yee Ho, Singapore (SG); Szu-Han Hu, Pathumthani (TH)

Correspondence Address: SUGHRUE MION, PLLC, 2100 Pennsylvania Avenue, N.W., Washington, DC, 20037, US

(73) Assignee: NITTO DENKO CORPORATION, Osaka (JP)

(21) Appl. No.: 11/548,684

(22) Filed: Oct. 11, 2006

(51) Int. Cl. G11B 5/55

(52) U.S. Cl. 360/264.2

(57) ABSTRACT

An actuator assembly for a hard disk drive having an actuator arm; a carrier plate of a thermally conductive material mounted onto the actuator arm; a circuitry substrate mounted onto the carrier plate, the substrate comprising a stiffener layer made of conductive material and electrical circuitry; a preamp wire-bond chip bonded to the stiffener layer and contact wires connected between the preamp and the electrical circuitry.

### BACKGROUND

1. Field of the Invention

The subject invention relates to hard drives and, more particularly, for controlling the heat generated by the hard disk drive heads' preamp.

2. Related Art

FIG. 1 is a reproduction of FIG. 1 of U.S. Pat. No. 6,784,536, which is incorporated herein by reference in its entirety. FIG. 1 depicts a wire-bond chip that is generally used in electronic circuits. In FIG. 1 the semiconductor chip 40 is bonded to a conductive substrate 34, so that the substrate functions as a heat sink. Insulative stack 32 is provided on top of the substrate 34, and solder bumps 70 are provided on top of the insulative stack 32. Conductive wires 42 are connected between contact pads on the chip 40 and contact pads on the insulative stack (not referenced in the '536 patent), so as to form a wire-bond connection arrangement. An insulation epoxy 44 is provided over the wire-bond arrangement and the chip 40 The entire arrangement shown in FIG. 1 is then soldered to a printed circuit board (PCB) via solder bump 70. FIG. 2 illustrates the same arrangement as disclosed in the '536 patent, except that the solder bumps 70 are shown soldered to PCB 200, which was omitted in the '536 patent.

A problem with the prior art arrangement, such as that shown in the '536 patent, is that it does not provide proper heat removal from the chip. The path to the PCB 200 via the solder bumps 70 is insufficient to provide heat removal. On the other hand, the conductive substrate 34 is insufficient for heat removal, as the heat accumulated by the substrate 34 may only be removed by convection to the ambient air. Moreover, the '536's proposal to add another insulation layer 50 at the underside of the conductive layer 34 exacerbate the problem as it insulates the conductive substrate 34 from the ambient air. Consequently, heat is dissipated mostly to the air via the path shown by the arrows. However, there is a need in the art for better heat removal from wire-bond chips.

Integrated circuit chips, in the form of preamps are also used in the hard drive industry; however, for such application the prior art approach is to use a “flip chip” arrangement, such as that described in, for example, U.S. Pat. No. 6,480,362, which is incorporated herein by reference in its entirety. The flip chip is depicted as element 100 in, e.g., FIG. 11 of the '362 patent. As is know, when using flip chips, solder bumps are used to make the electrical contact to the circuit and also to physically holds the chip in place. Therefore, the packaging of the flip chip differs from wire-bond chips and the mechanical and electrical means of contacting it differs from wire-bond chip.

As the physical size of the hard drive decrease, the heat generated by the preamp affects performance and reliability of the hard drive. Accordingly, there is a need in the art for an improved efficiency of removing heat from the preamp chip. Also, in view of the diversity of preamps chips available on the market, it is desirable to provide a solution enabling the use of wire-bond chips for hard drive preamps.

### SUMMARY

The present invention has been made in order to enable the use of wire-bond preamps in hard drive application. The present invention has been made by observing a problem in the prior art, in that the heat generated by a wire-bond preamp used in general electronic is not readily dissipated. While the metal substrate of a wire-bond chip arrangement has been used as a heat sink, the inventors of the subject application have discovered that the metal substrate in itself is insufficient for heat removal from contemporary preamp chips. Accordingly, the inventors have invented schemes to better remove heat from a wire-bond preamp chip by providing a thermal conduit from the preamp to the carrier arm.

According to an aspect of the invention, an assembly for an integrated circuit chip is provided which comprises a carrier plate of a thermally conductive material; a substrate bonded to the carrier plate, the substrate comprising: a stiffener layer made of first conductive material; an insulating layer provided over circuitry area of said substrate, said insulating layer having a window defined therein; a circuitry of a second conductive material provided over said insulating layer and including contact pads; and, a preamp wire-bond chip bonded to the stiffener layer via the window and having contact wires connected between the preamp and the contact pads. The first conductive material may be stainless steel or aluminum and the second conductive material may be aluminum or copper. The assembly may also comprise flexible circuit loop connected at one end thereof to the circuitry. The assembly may further comprises a thermally conductive adhesive bonding the substrate to the carrier plate. The assembly may further comprise a thermally conductive adhesive bonding the chip to the stiffener layer. The assembly may further comprise an electrically insulative adhesive injected over the chip and contact wires. The assembly may further comprise an electrically conductive layer provided over the insulative adhesive. The assembly may further comprise grounding contacts provided over the insulative layer and in electrical contact with the electrically conductive layer.

According to another aspect of the invention, an actuator assembly for a hard disk drive is provided, comprising: an actuator arm; a carrier plate of a thermally conductive material mounted onto the actuator arm; a circuitry substrate mounted onto the carrier plate, said substrate comprising a stiffener layer made of conductive material and electrical circuitry; a preamp wire-bond chip bonded to the stiffener layer; and, contact wires connected between the preamp and the electrical circuitry. The substrate may further comprise an insulating layer provided over circuitry area of the stiffener layer and having a window therein; and wherein the electrical circuitry is provided over the insulating layer. The chip may be bonded to the stiffener through the window in the insulating layer. The assembly may further comprise flexible circuit loop connected at one end thereof to the electrical circuitry. The assembly may further comprise a thermally conductive adhesive bonding the substrate to the carrier plate. The assembly may further comprise a thermally conductive adhesive bonding the chip to the stiffener layer. The assembly may further comprise an electrically insulative adhesive injected over the chip and contact wires. The assembly may further comprise an electrically conductive layer provided over the insulative adhesive. The assembly may further comprise grounding contacts provided on the electrical circuitry and in electrical contact with the electrically conductive layer.

According to a further aspect of the invention, a method for manufacturing a preamp assembly for a hard drive is provided, comprising: providing a substrate, said substrate comprising a stiffener layer, an insulating layer provided on the stiffener and having a window exposing the stiffener layer, and an electrical circuitry on the insulating layer; bonding the preamp on the stiffener layer through the window; wire-bonding wires so as to form electrical connection between the preamp and the electrical circuitry; and bonding the substrate onto a carrier plate. The method may further comprise injective insulative adhesive over the preamp and the contact wires. The method may further comprise providing a shielding conductive layer over the insulative adhesive. The method may further comprise providing a grounding contact to the shielding conductive layer.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

Other aspects and features of the invention would be apparent from the detailed description, which is made with reference to the following drawings. It should be appreciated that the detailed description and the drawings provide various non-limiting examples of various embodiments of the invention, which is defined by the appended claims.

FIG. 1 is reproduction of FIG. 1 of U.S. Pat. No. 6,784,536.

FIG. 2 illustrates the same arrangement as disclosed in the '536 patent, except that the solder bumps 70 are shown soldered to PCB 200, which was omitted in the '536 patent.

FIGS. 3a and 3b depict a hard drive suitable for implementing embodiments of the subject invention.

FIG. 4 depicts an arrangement of carrier plate, substrate, and wire-bond preamp according to an embodiment of the invention.

FIG. 5 is a cross section depicting an embodiment of the invention.

FIG. 6 depicts another embodiment of the invention.

FIG. 7 a sheet of substrates according to an embodiment of the invention.

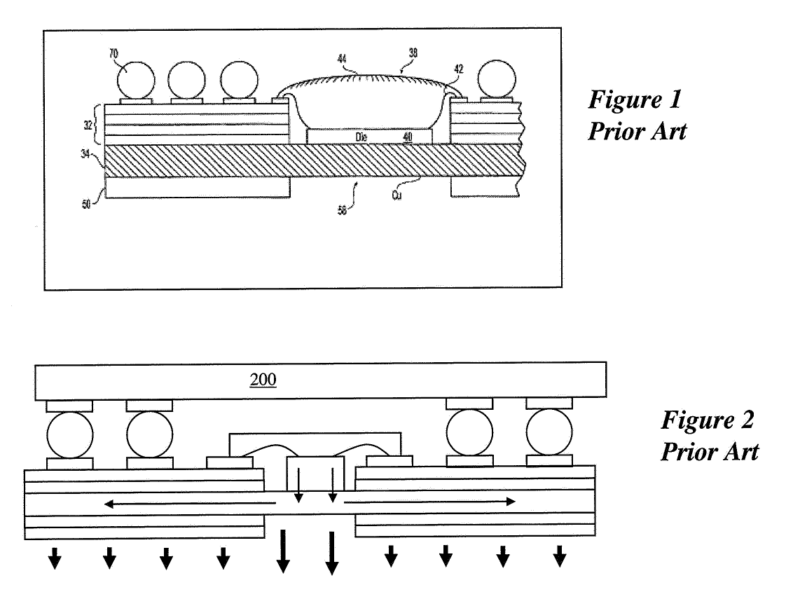

### DETAILED DESCRIPTION

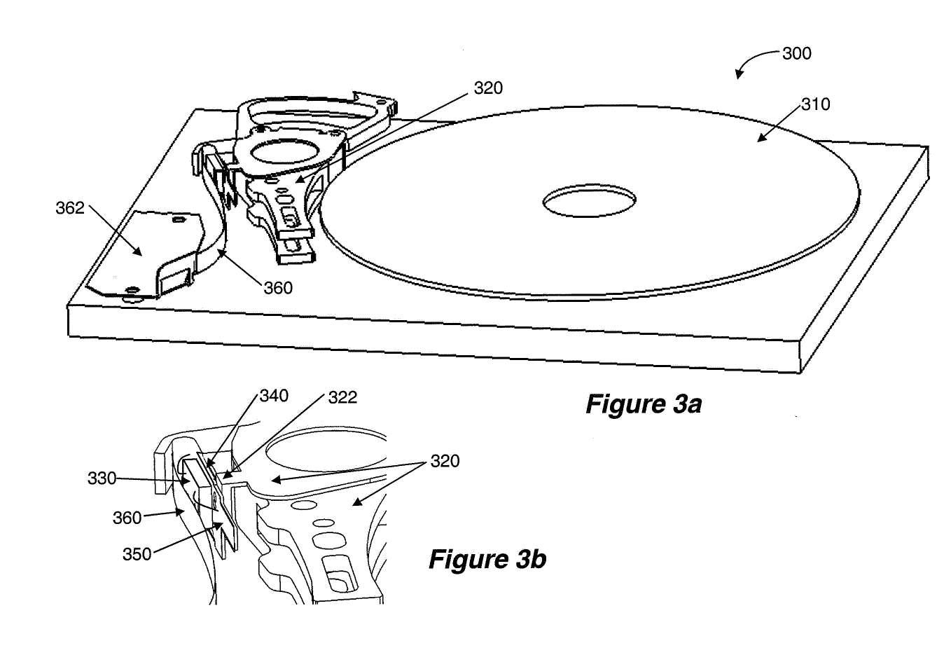

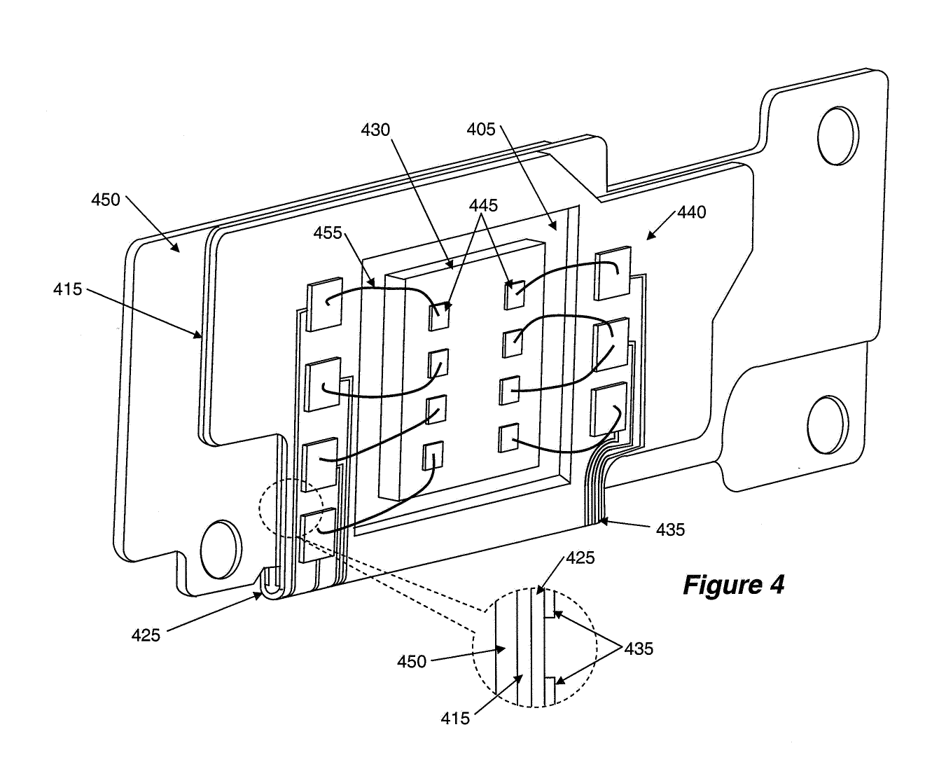

FIGS. 3a and 3b depict a hard drive suitable for implementing embodiments of the subject invention. FIG. 3a depicts the hard drive 300 with the cover removed, while FIG. 3b depicts an enlarged image of the preamp area of the hard drive. The hard drive 300 uses rotating platters (disks) 310 to store data. Each platter is rotated by a spindle (not shown) and has a smooth magnetic surface on which digital data is stored. Information is written to the disk by applying a magnetic field from a read-write head (not shown) that is attached to an actuator arm 320. For reading, the read-write head detects the magnetic flux emanating from the magnetic bits that were written onto the platter. Since the signals from the read/write head is very faint, a preamp 330 is provided in close proximity to the head. The preamp 330 is a chip that is mounted on a substrate 340. The substrate 340 is mounted onto a carrier plate 350, that connects to the actuator arm assembly 320. The flexible circuit loop 360 is connected to the substrate 340, to transfer signals between the preamp 330 and the associated electronics (not shown). The associated electronics control the movement of the actuator and the rotation of the disk, and perform reads and writes on demand from the disk controller.

FIG. 4 depicts an arrangement of carrier plate, substrate, and wire-bond preamp according to an embodiment of the invention. In FIG. 4, the substrate 440 is mounted onto carrier plate 450. As shown in the cross-section inside the broken-line callout, the substrate is generally made of a stainless steel or aluminum backing, generally referred to as a stiffener, 415, an insulating layer, e.g., polyimide, 425, and copper conducting contacts and lines 435. The preamp 430 is attached to the stiffener 415 of the substrate 440 via cutout or window 405 in the insulating layer 440. The contact pads 445 of the preamp chip 430 are connected to the copper contacts 435 via conductive wires 455. An insulative epoxy may be provided on top of preamp 430, wires 455 and contacts 435, but is not shown herein for clarity. In the case depicted, substrate 440, having its own stiffener 415, folds back over carrier plate 450. Carrier plate 450 and stiffener 415 can be made from a common metal layer. Alternate designs integrate the function of the carrier plate 450 into the stiffener 415, eliminating the need for the carrier plate 450.

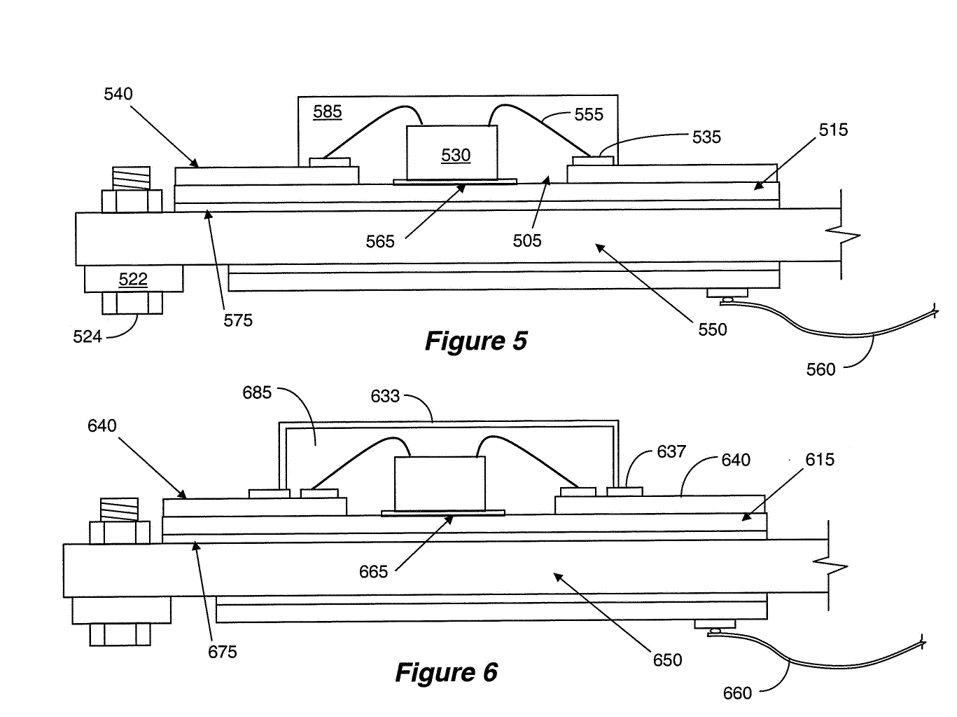

FIG. 5 is a cross section depicting an embodiment of the invention. In FIG. 5, the carrier plate 550 is bolted onto protrusion 522 (shown as 322 in FIG. 3b) of actuator arm assembly 320, thereby making a heat conductive path. While in this embodiment a bolt 524 is used as the fastening means, other methods may be used, but heat conductive methods would provide improved results. Also, the carrier plate 550 is connected to other sections of the actuator arm assembly, but it is not shown in FIG. 5. The stiffener 515 is bonded to the carrier plate 550 using heat conductive adhesive 575. One type of adhesive that is suitable for use with the embodiments described herein is TIGA HTR-815 epoxy, available from Resin Technology Group of South Easton, Mass. This epoxy has thermal conductivity of 1.15 W/m-K. This enables good thermal conductivity between the stiffener 515 and the carrier plate 550. The preamp chip 530 is also bonded to the stiffener 515 in a window 505 formed in the insulating layer 540. Again, a thermally conductive adhesive should be used. In this manner, good thermal conductivity is provided from the preamp chip 530, via the stiffener 515, the carrier arm 550, to the actuator arm assembly 320, forming a relatively large heat sink for the preamp chip 530.

The preamp 530 receives and sends signals via the wires 555 that are connected to contact pads 535 provided on the insulating layer 540. The contact pads 535 are connected to wiring circuitry that is also formed on the insulating layer 540, and provides contact to flexible circuit loop 560. The flexible circuit loop 560 is connected at its other end (see FIG. 3a) to a connector provided on metal bracket 362 (the complete arrangement can be seen in the '362 patent). In this manner, the chip 530 is mounted onto the stiffener 515 which is bonded to the carrier plate 550, which in turns is mounted onto the actuator arm assembly 520, to provide improved heat removal. The PCB is mounted remotely from the preamp 530 and is connected to the preamp 530 via the flexible circuit loop 560. In this embodiment, insulating adhesive 585 is provided over the preamp 530 and wires 555 for protection.

FIG. 6 depicts another embodiment of the invention. The embodiment of FIG. 6 is very similar to that of FIG. 5, except that in the embodiment of FIG. 6 a conductive layer 533, such as a conductive paint, is provided over the insulating adhesive 685. This conductive layer assists in preventing electromagnetic interference (EMI) with the preamp. To improve this protection, contact pads 637 are provided over the insulative layer 640 so as to contact the conductive layer 633. The contact pads 637 are grounded so as to also ground the conductive layer 633. In this embodiment, it would be advantageous to use a heat conductive adhesive for insulation adhesive 685. This embodiment is especially beneficial for high frequency integrated circuit applications, as such application generate a relatively large amount of heat and may require enhanced EMI protection.

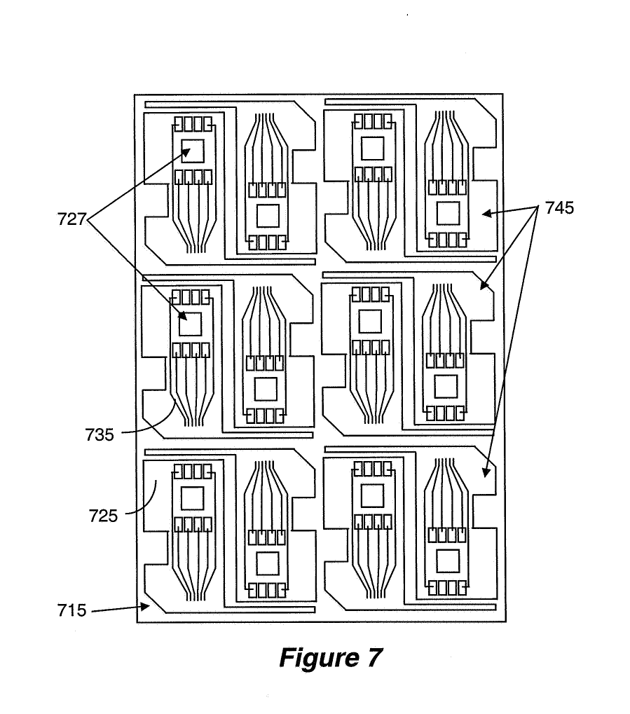

FIG. 7 depicts a sheet of substrates according to an embodiment of the invention. The substrates are generally made using a sheet of stiffener material 715, upon which an insulation layer and conductive circuit layer are formed. As depicted in FIG. 7, a sheet of stiffener material, such as stainless steel or aluminum, 715, serves as a starting material for fabricating the substrates 745. For each substrate 745, an insulation layer, such as a polyimide layer, 725 is deposited on top of the stiffener 715 to serve as an electrical insulator. The insulation layer 725 is deposited according to a predetermined design, so that it does not cover the entire surface of the stiffener layer 715. Notably, a window 727 is provided at the location where the preamp chip would be bonded to the stiffener 715. On top of the insulation layer 725, various conductive elements 735 are deposited to form conductive circuitry of contacts and transmission lines. The fabrication of these layers is done using conventional photolithography techniques. Both subtractive and additive flexible circuit fabrication processes are commonly employed in hard disk drives manufacturing. To maximize the available real estate, the substrates 745 are fabricated so as to “nest” with each other, and after the fabrication is completed the substrates 745 are cut out of the stiffener sheet 715.

Thus, while only certain embodiments of the invention have been specifically described herein, it will be apparent that numerous modifications may be made thereto without departing from the spirit and scope of the invention. Further, certain terms have been used interchangeably merely to enhance the readability of the specification and claims. It should be noted that this is not intended to lessen the generality of the terms used and they should not be construed to restrict the scope of the claims to the embodiments described therein.

1. An assembly for an integrated circuit chip, comprising:
a carrier plate of a thermally conductive material;
a substrate bonded to the carrier plate, said substrate comprising:
a stiffener layer made of first conductive material;
an insulating layer provided over circuitry area of said substrate, said insulating layer having a window defined therein;
a circuitry of a second conductive material provided over said insulating layer and including contact pads; and,
a preamp wire-bond chip bonded to the stiffener layer via the window and having contact wires connected between the preamp and the contact pads.

2. The assembly of claim 1, wherein the first conductive material comprises stainless steel.

3. The assembly of claim 1, wherein the second conductive material comprises copper.

4. The assembly of claim 1, further comprising flexible circuit loop connected at one end thereof to the circuitry.

5. The assembly of claim 1, further comprising a thermally conductive adhesive bonding the substrate to the carrier plate.

6. The assembly of claim 1, further comprising a thermally conductive adhesive bonding the chip to the stiffener layer.

7. The assembly of claim 1, further comprising an electrically insulative adhesive injected over the chip and contact wires.

8. The assembly of claim 7, further comprising an electrically conductive layer provided over the insulative adhesive.

9. The assembly of claim 8, further comprising grounding contacts provided over the insulative layer and in electrical contact with the electrically conductive layer.

10. An actuator assembly for a hard disk drive, comprising:
an actuator arm;
a carrier plate of a thermally conductive material mounted onto the actuator arm;
a circuitry substrate mounted onto the carrier plate, said substrate comprising a stiffener layer made of conductive material and electrical circuitry;
a preamp wire-bond chip bonded to the stiffener layer; and,
contact wires connected between the preamp and the electrical circuitry.

11. The assembly of claim 10, wherein said substrate further comprises an insulating layer provided over circuitry area of the stiffener layer and having a window therein; and wherein the electrical circuitry is provided over the insulating layer.

12. The assembly of claim 11, wherein said chip is bonded to the stiffener through the window in the insulating layer.

13. The assembly of claim 10, further comprising flexible circuit loop connected at one end thereof to the electrical circuitry.

14. The assembly of claim 10, further comprising a thermally conductive adhesive bonding the substrate to the carrier plate.

15. The assembly of claim 10, further comprising a thermally conductive adhesive bonding the chip to the stiffener layer.

16. The assembly of claim 10, further comprising an electrically insulative adhesive injected over the chip and contact wires.

17. The assembly of claim 16, further comprising an electrically conductive layer provided over the insulative adhesive.

18. The assembly of claim 17, further comprising grounding contacts provided on the electrical circuitry and in electrical contact with the electrically conductive layer.

19. A method for manufacturing a preamp assembly for a hard drive, comprising:
providing a substrate, said substrate comprising a stiffener layer, an insulating layer provided on the stiffener and having a window exposing the stiffener layer, and an electrical circuitry on the insulating layer;
bonding the preamp on the stiffener layer through the window;
wirebonding contact wires so as to form electrical connection between the preamp and the electrical circuitry; and,
bonding the substrate onto a carrier plate.

20. The method of claim 19, further comprising injective insulative adhesive over the preamp and the contact wires.

21. The method of claim 20, further comprising providing a shielding conductive layer over the insulative adhesive.

22. The method of claim 21, further comprising providing a grounding contact to the shielding conductive layer.
